(19) United States
(12) Patent Application Publication
(10) Pub. No.: US 2024/0373484 A1
(43) Pub. Date: Nov. 7, 2024

(54) APPARATUS, METHOD, AND COMPUTER PROGRAM

(71) Applicant: Nokia Technologies Oy, Espoo (FI)

(72) Inventors: Zhijie YANG, Shanghai (CN); Mika KASSLIN, Espoo (FI); Lorenzo Galati GIORDANO, Stuttgart (DE)

(21) Appl. No.: 18/561,327

(22) PCT Filed: May 20, 2021
(86) PCT No.: PCT/CN2021/094990

§ 371 Date: Nov. 16, 2023

(51) Int. Cl. H04W 76/14; H04L 12/18; H04W 84/12

(52) U.S. Cl. CPC H04W 76/14; H04L 12/189; H04W 84/12

(57) ABSTRACT

The disclosure relates to an apparatus comprising at least one processor and at least one memory including computer code for one or more programs, the at least one memory and the computer code configured, with the at least one processor, to cause the apparatus at least to: configure (1300) a link to receive groupcast frames among multiple links between the apparatus and an access node apparatus; and send (1302) an indication to the access node apparatus indicating the link configured to receive the groupcast frames.

### FIELD OF THE DISCLOSURE

The present disclosure relates to an apparatus, a method, and a computer program for sending an indication to an access node apparatus indicating a link configured to receive groupcast frames among multiple links between a non-access node apparatus and the access node apparatus. The access node may be an access point or a base station. The access node apparatus and the non-access node apparatus may be nodes of a wireless network, such as wireless local area network or a cellular network.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided an apparatus comprising means for: configuring a link to receive groupcast frames among multiple links between the apparatus and an access node apparatus; and sending an indication to the access node apparatus indicating the link configured to receive the groupcast frames.

The link configured to receive the groupcast frames may be between a station of the apparatus and an access node of the access node apparatus, wherein the station is in power active mode.

The apparatus may comprise means for: configuring one or more other links to receive the groupcast frames or to abstain from receiving the groupcast frames among the multiple links between the apparatus and the access node apparatus.

The one or more other links configured to receive the groupcast frames or to abstain from receiving the groupcast frames may be between other stations of the apparatus and other access nodes of the access node apparatus, wherein the one or more other stations of the apparatus are in power save mode.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate multiple links between the apparatus and the access node apparatus.

The control identifier may have a value comprised between ‘7’ and ‘14’.

The control information may indicate an identifier of the link configured to receive the groupcast frames.

The apparatus may comprise means for: receiving an indication from the access node apparatus indicating a suggested link to receive groupcast frames among the multiple links between the apparatus and the access node apparatus; and configuring the suggested link to receive the groupcast frames.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate a mode control with multiple links between the apparatus and an access node apparatus.

The control identifier may have a value comprised between ‘7’ and ‘14’.

The control information may indicate an identifier of the suggested link configured to receive a groupcast frame among the multiple links between the apparatus and an access node apparatus.

The groupcast frames may provide an IPTV service.

According to an aspect there is provided an apparatus comprising at least one processor and at least one memory including computer code for one or more programs, the at least one memory and the computer code configured, with the at least one processor, to cause the apparatus at least to: configure a link to receive groupcast frames among multiple links between the apparatus and an access node apparatus; and send an indication to the access node apparatus indicating the link configured to receive the groupcast frames.

The link configured to receive the groupcast frames may be between a station of the apparatus and an access node of the access node apparatus, wherein the station is in power active mode.

The at least one memory and the computer code may be configured, with the at least one processor, to cause the apparatus at least to: configure one or more other links to receive the groupcast frames or to abstain from receiving the groupcast frames among the multiple links between the apparatus and the access node apparatus.

The one or more other links configured to receive the groupcast frames or to abstain from receiving the groupcast frames may be between other stations of the apparatus and other access nodes of the access node apparatus, wherein the one or more other stations of the apparatus are in power save mode.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate multiple links between the apparatus and the access node apparatus.

The control identifier may have a value comprised between ‘7’ and ‘14’.

The control information may indicate an identifier of the link configured to receive the groupcast frames.

The at least one memory and the computer code may be configured, with the at least one processor, to cause the apparatus at least to: receive an indication from the access node apparatus indicating a suggested link to receive groupcast frames among the multiple links between the apparatus and the access node apparatus; and configure the suggested link to receive the groupcast frames.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate a mode control with multiple links between the apparatus and an access node apparatus.

The control identifier may have a value comprised between ‘7’ and ‘14’.

The control information may indicate an identifier of the suggested link configured to receive a groupcast frame among the multiple links between the apparatus and an access node apparatus.

The groupcast frames may provide an IPTV service.

According to an aspect there is provided an apparatus comprising circuitry configured to: configure a link to receive groupcast frames among multiple links between the apparatus and an access node apparatus; and send an indication to the access node apparatus indicating the link configured to receive the groupcast frames.

The link configured to receive the groupcast frames may be between a station of the apparatus and an access node of the access node apparatus, wherein the station is in power active mode.

The apparatus may comprise circuitry configured to: configure one or more other links to receive the groupcast frames or to abstain from receiving the groupcast frames among the multiple links between the apparatus and the access node apparatus.

The one or more other links configured to receive the groupcast frames or to abstain from receiving the groupcast frames may be between other stations of the apparatus and other access nodes of the access node apparatus, wherein the one or more other stations of the apparatus are in power save mode.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate multiple links between the apparatus and the access node apparatus.

The control identifier may have a value comprised between ‘7’ and ‘14’.

The control information may indicate an identifier of the link configured to receive the groupcast frames.

The apparatus may comprise circuitry configured to: receive an indication from the access node apparatus indicating a suggested link to receive groupcast frames among the multiple links between the apparatus and the access node apparatus; and configure the suggested link to receive the groupcast frames.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate a mode control with multiple links between the apparatus and an access node apparatus.

The control identifier may have a value comprised between ‘7’ and ‘14’.

The control information may indicate an identifier of the suggested link configured to receive a groupcast frame among the multiple links between the apparatus and an access node apparatus.

The groupcast frames may provide an IPTV service.

According to an aspect there is provided a method comprising: configuring a link to receive groupcast frames among multiple links between the apparatus and an access node apparatus; and sending an indication to the access node apparatus indicating the link configured to receive the groupcast frames.

The link configured to receive the groupcast frames may be between a station of the apparatus and an access node of the access node apparatus, wherein the station is in power active mode.

The method may comprise: configuring one or more other links to receive the groupcast frames or to abstain from receiving the groupcast frames among the multiple links between the apparatus and the access node apparatus.

The one or more other links configured to receive the groupcast frames or to abstain from receiving the groupcast frames may be between other stations of the apparatus and other access nodes of the access node apparatus, wherein the one or more other stations of the apparatus are in power save mode.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate multiple links between the apparatus and the access node apparatus.

The control identifier may have a value comprised between ‘7’ and ‘14’.

The control information may indicate an identifier of the link configured to receive the groupcast frames.

The method may comprise: receiving an indication from the access node apparatus indicating a suggested link to receive groupcast frames among the multiple links between the apparatus and the access node apparatus; and configuring the suggested link to receive the groupcast frames.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate a mode control with multiple links between the apparatus and an access node apparatus.

The control identifier may have a value comprised between ‘7’ and ‘14’.

The control information may indicate an identifier of the suggested link configured to receive a groupcast frame among the multiple links between the apparatus and an access node apparatus.

The groupcast frames may provide an IPTV service.

According to an aspect there is provided a computer program comprising computer executable code which when run on at least one processor is configured to: configure a link to receive groupcast frames among multiple links between the apparatus and an access node apparatus; and send an indication to the access node apparatus indicating the link configured to receive the groupcast frames.

The link configured to receive the groupcast frames may be between a station of the apparatus and an access node of the access node apparatus, wherein the station is in power active mode.

The computer program may comprise computer executable code which when run on at least one processor is configured to: configure one or more other links to receive the groupcast frames or to abstain from receiving the groupcast frames among the multiple links between the apparatus and the access node apparatus.

The one or more other links configured to receive the groupcast frames or to abstain from receiving the groupcast frames may be between other stations of the apparatus and other access nodes of the access node apparatus, wherein the one or more other stations of the apparatus are in power save mode.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate multiple links between the apparatus and the access node apparatus.

The control identifier may have a value comprised between ‘7’ and ‘14’.

The control information may indicate an identifier of the link configured to receive the groupcast frames.

The computer program may comprise computer executable code which when run on at least one processor is configured to: receive an indication from the access node apparatus indicating a suggested link to receive groupcast frames among the multiple links between the apparatus and the access node apparatus; and configure the suggested link to receive the groupcast frames.

The indication may be sent on the link configured to receive the groupcast frames.

The indication may be comprised in a control field of a medium access control header.

The indication may be comprised in a high throughput control field of a medium access control header.

The indication may be comprised in a high efficiency variant of a high throughput control field of a medium access control header.

The indication may be comprised in a control subfield of an A-Control subfield of a high efficiency variant of a high throughput control field of a medium access control header.

The control subfield may comprise a control identifier and control information.

The control identifier may indicate a mode control with multiple links between the apparatus and an access node apparatus.

The control identifier may have a value comprised between ‘7’ and ‘14’.

The control information may indicate an identifier of the suggested link configured to receive a groupcast frame among the multiple links between the apparatus and an access node apparatus.

The groupcast frames may provide an IPTV service.

According to an aspect there is provided an apparatus comprising means for: receiving an indication from a non-access node apparatus indicating a link configured to receive groupcast frames among multiple links between the non-access node apparatus and the apparatus; transmitting the groupcast frames at least on the link configured to receive the groupcast frames among the multiple links between the non-access node apparatus and the apparatus; and buffering the groupcast frames for transmission on another link among the multiple links between the non-access node apparatus and the apparatus only if there is at least one link between a station and an access node of the apparatus, wherein the station is in power save mode and the at least one link is configured to receive groupcast frames, wherein the station is a station of the non-access node apparatus or a station of another non-access node apparatus.

The link configured to receive the groupcast frames may be between a station of the non-access node apparatus and an access node of the apparatus, wherein the station of the non-access node apparatus is in power active mode.

The apparatus may comprise means for: configuring the access node of the access node apparatus to send the groupcast frames.

The apparatus may comprise means for: determining that one or more other links are configured to receive the groupcast frames or to abstain from receiving the groupcast frames among the multiple links between the non-access node apparatus and the apparatus.

The one or more other links configured to receive the groupcast frames or to abstain from receiving the groupcast frames may be between other stations of the non-access node apparatus and other access nodes of the apparatus, wherein the other stations of the non-access node apparatus are in power save mode.

The apparatus may comprise means for: sending an indication to the non-access node apparatus indicating a suggested link to receive a groupcast frame among the multiple links.

According to an aspect there is provided an apparatus comprising at least one processor and at least one memory including computer code for one or more programs, the at least one memory and the computer code configured, with the at least one processor, to cause the apparatus at least to: receive an indication from a non-access node apparatus indicating a link configured to receive groupcast frames among multiple links between the non-access node apparatus and the apparatus; transmit the groupcast frames at least on the link configured to receive the groupcast frames among the multiple links between the non-access node apparatus and the apparatus; and buffer the groupcast frames for transmission on another link among the multiple links between the non-access node apparatus and the apparatus only if there is at least one link between a station and an access node of the apparatus,
wherein the station is in power save mode and the at least one link is configured to receive groupcast frames, wherein the station is a station of the non-access node apparatus or a station of another non-access node apparatus.

The link configured to receive the groupcast frames may be between a station of the non-access node apparatus and an access node of the apparatus, wherein the station of the non-access node apparatus is in power active mode.

The at least one memory and the computer code may be configured, with the at least one processor, to cause the apparatus at least to: configure the access node of the access node apparatus to send the groupcast frames.

The at least one memory and the computer code may be configured, with the at least one processor, to cause the apparatus at least to: determine that one or more other links are configured to receive the groupcast frames or to abstain from receiving the groupcast frames among the multiple links between the non-access node apparatus and the apparatus.

The one or more other links configured to receive the groupcast frames or to abstain from receiving the groupcast frames may be between other stations of the non-access node apparatus and other access nodes of the apparatus, wherein the other stations of the non-access node apparatus are in power save mode.

The at least one memory and the computer code may be configured, with the at least one processor, to cause the apparatus at least to: send an indication to the non-access node apparatus indicating a suggested link to receive a groupcast frame among the multiple links.

According to an aspect there is provided an apparatus comprising circuitry configured to: receive an indication from a non-access node apparatus indicating a link configured to receive groupcast frames among multiple links between the non-access node apparatus and the apparatus; transmit the groupcast frames at least on the link configured to receive the groupcast frames among the multiple links between the non-access node apparatus and the apparatus; and buffer the groupcast frames for transmission on another link among the multiple links between the non-access node apparatus and the apparatus only if there is at least one link between a station and an access node of the apparatus, wherein the station is in power save mode and the at least one link is configured to receive groupcast frames, wherein the station is a station of the non-access node apparatus or a station of another non-access node apparatus.

The link configured to receive the groupcast frames may be between a station of the non-access node apparatus and an access node of the apparatus, wherein the station of the non-access node apparatus is in power active mode.

The apparatus may comprise circuitry configured to: configure the access node of the access node apparatus to send the groupcast frames.

The apparatus may comprise circuitry configured to: determine that one or more other links are configured to receive the groupcast frames or to abstain from receiving the groupcast frames among the multiple links between the non-access node apparatus and the apparatus.

The one or more other links configured to receive the groupcast frames or to abstain from receiving the groupcast frames may be between other stations of the non-access node apparatus and other access nodes of the apparatus, wherein the other stations of the non-access node apparatus are in power save mode.

The apparatus may comprise circuitry configured to: send an indication to the non-access node apparatus indicating a suggested link to receive a groupcast frame among the multiple links.

According to an aspect there is provided a method comprising: receiving an indication from a non-access node apparatus indicating a link configured to receive groupcast frames among multiple links between the non-access node apparatus and the apparatus; transmitting the groupcast frames at least on the link configured to receive the groupcast frames among the multiple links between the non-access node apparatus and the apparatus; and buffering the groupcast frames for transmission on another link among the multiple links between the non-access node apparatus and the apparatus only if there is at least one link between a station and an access node of the apparatus, wherein the station is in power save mode and the at least one link is configured to receive groupcast frames, wherein the station is a station of the non-access node apparatus or a station of another non-access node apparatus.

The link configured to receive the groupcast frames may be between a station of the non-access node apparatus and an access node of the apparatus, wherein the station of the non-access node apparatus is in power active mode.

The method may comprise: configuring the access node of the access node apparatus to send the groupcast frames.

The method may comprise: determining that one or more other links are configured to receive the groupcast frames or to abstain from receiving the groupcast frames among the multiple links between the non-access node apparatus and the apparatus.

The one or more other links configured to receive the groupcast frames or to abstain from receiving the groupcast frames may be between other stations of the non-access node apparatus and other access nodes of the apparatus, wherein the other stations of the non-access node apparatus are in power save mode.

The method may comprise: sending an indication to the non-access node apparatus indicating a suggested link to receive a groupcast frame among the multiple links.

According to an aspect there is provided a computer program comprising computer executable code which when run on at least one processor is configured to: receive an indication from a non-access node apparatus indicating a link configured to receive groupcast frames among multiple links between the non-access node apparatus and the apparatus; transmit the groupcast frames at least on the link configured to receive the groupcast frames among the multiple links between the non-access node apparatus and the apparatus; and buffer the groupcast frames for transmission on another link among the multiple links between the non-access node apparatus and the apparatus only if there is at least one link between a station and an access node of the apparatus, wherein the station is in power save mode and the at least one link is configured to receive groupcast frames, wherein the station is a station of the non-access node apparatus or a station of another non-access node apparatus.

The link configured to receive the groupcast frames may be between a station of the non-access node apparatus and an access node of the apparatus, wherein the station of the non-access node apparatus is in power active mode.

The computer program may comprise computer executable code which when run on at least one processor is configured to: configure the access node of the access node apparatus to send the groupcast frames.

The computer program may comprise computer executable code which when run on at least one processor is configured to: determine that one or more other links are configured to receive the groupcast frames or to abstain from receiving the groupcast frames among the multiple links between the non-access node apparatus and the apparatus.

The one or more other links configured to receive the groupcast frames or to abstain from receiving the groupcast frames may be between other stations of the non-access node apparatus and other access nodes of the apparatus, wherein the other stations of the non-access node apparatus are in power save mode.

The computer program may comprise computer executable code which when run on at least one processor is configured to: send an indication to the non-access node apparatus indicating a suggested link to receive a groupcast frame among the multiple links.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AMF: Access and Mobility Management Function
AP: Access Point
API: Application Protocol Interface
BS: Base Station
CU: Centralized Unit
DL: Downlink
DU: Distributed Unit
ER: Extended Range
GC: Groupcast
gNB: gNodeB
GSM: Global System for Mobile communication
HE: High Efficiency
HSS: Home Subscriber Server
ID: Identifier
IEEE: Institute of Electrical and Electronics Engineers
IPTV: Internet Protocol Television
IoT: Internet of Things
LDPC: Low Density Parity Check
LTE: Long Term Evolution
MAC: Medium Access Control
MLD: Multi-Link Device
MS: Mobile Station
MTC: Machine Type Communication
MU-MIMO: Multi-User Multiple Input Multiple Output
NEF: Network Exposure Function
NF: Network Function
NR: New radio
NRF: Network function Repository Function
NSS: Number of Spatial Streams
NSTS: Number of Space-Time Streams
OM: Operating Mode
OMI: Operating Mode Indication
PDU: Packet Data Unit
PHY: Physical
PS: Power Saving
QOS: Quality of Service
RAM: Random Access Memory
(R)AN: (Radio) Access Network
ROM: Read Only Memory
Rx: Receive
SMF: Session Management Function
STA: Station
TG: Task group
TR: Technical Report
TS: Technical Specification
Tx: Transmit
UE: User Equipment
UL: Uplink
UMTS: Universal Mobile Telecommunication System
VHT: Very High Throughput
Wi-Fi: Wireless Fidelity
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of multiple links between an access point multi-link device and a non-access point multi-link device, wherein groupcast frames are duplicated on the multiple links;

FIG. 5 shows a medium access control header format;

FIG. 6 shows a high throughput control field format with three variants;

FIG. 7 shows a control subfield format;

FIG. 8 shows possible control identifiers and control information;

FIG. 9 shows a control information format when the control identifier indicates an operating mode;

FIG. 10 shows a legacy station experiencing delays in groupcast frame delivery due to a station of non-access point apparatus being in power save mode;

FIG. 11 shows two non-access point apparatus experiencing delays in groupcast frame delivery due to stations of the non-access point apparatus being in power save mode in an incompatible manner;

FIG. 12 shows a control information format to indicate a link configured to receive groupcast frames among multiple links between a non-access point multi-link device and the access point multi-link device

FIG. 13 shows a block diagram of a method for sending an indication to an access point multi-link device indicating a link configured to receive groupcast frames among multiple links between a non-access point multi-link device and the access point multi-link device;

FIG. 14 shows a block diagram of a method for receiving an indication from an access point multi-link device indicating a link configured to receive groupcast frames among multiple links between a non-access point multi-link device and the access point multi-link device; and

FIG. 15 shows a schematic representation of a non-volatile memory medium storing instructions which when executed by a processor allow a processor to perform one or more of the steps of the methods of FIGS. 14 and 15.

### DETAILED DESCRIPTION OF THE FIGURES

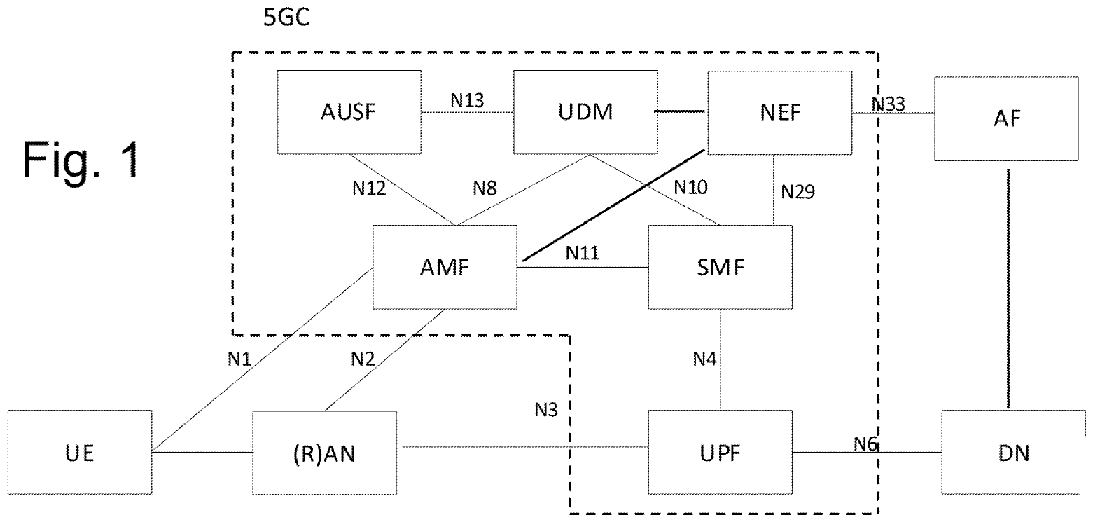

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF) and/or a network exposure function (NEF).

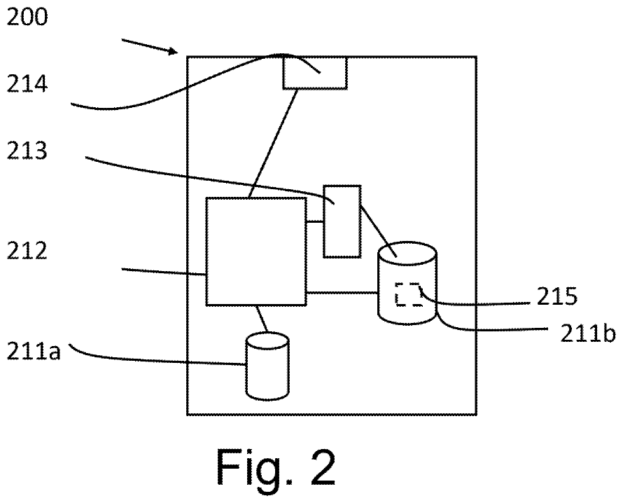

FIG. 2 illustrates an example of a control apparatus 200 for controlling a device of the (R)AN, such as an access point multi-link device (AP MLD), or a function of the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another device of the (R)AN or another function of the 5G (R)AN or the 5GC. In some embodiments, each device of the (R)AN or function the 5GC comprises a control apparatus 200. In alternative embodiments, two or more devices of the (R)AN or function the 5GC may share a control apparatus.

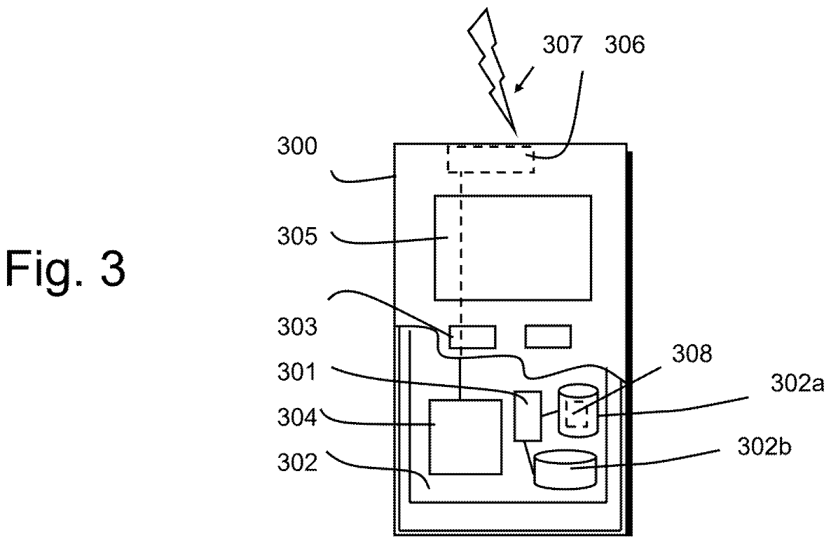

FIG. 3 illustrates an example of a terminal 300, such as the terminal illustrated on FIG. 1. The terminal 300 may be provided by any device capable of sending and receiving radio signals. The terminal 300 may be a non-AP multi-link device (non-AP MLD). The terminal 300 may be a user equipment, a mobile station (MS), mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

The institute of electrical and electronics engineers (IEEE) 802.11 working group has a task group TGbe developing the next major physical (PHY) and medium access control (MAC) release of the 802.11 specification. The PHY and MAC release of the 802.11 specification is going to be defined in the 802.11be amendment and is expected to be the basis of wireless fidelity (Wi-Fi) 7. One of the main features defined by the task group TGbe is multi-link.

Multi-link capable devices are often called multi-link devices (MLD). An MLD may be an access point (AP) MLD or a non-AP MLD. An AP MLD may comprise multiple APs. A non-AP MLD may comprise multiple stations (STA).

An AP MLD and a non-AP MLD supporting 802.11be multi-link may establish multiple links between the multiple APs of the AP MLD and the multiple STAs of the non-AP MLD. The multiple links may operate on different channels. For example, an AP MLD and a non-AP MLD may establish three links. The three links may operate simultaneously. A first link may operate on a channel in the 2.4 GHz band. A second link may operate on a channel in the 5 GHz band. A third link may operate on a channel in the 6 GHz band.

In this document, a “link” may refer to a link established between a STA (e.g. a legacy STA or a STA of a non-AP MLD) and an AP (e.g. an AP of an AP MDL) on a channel.

Each STA of a non-AP MLD connected to an AP of an AP MLD may maintain its own power management mode and power state as specified in the IEEE 802.11 specification. There may be no power management mode and power state transitions at the MLD level. To the contrary, there may be power management mode and power state transitions at the link level. That is, power management mode and power state transitions may be taken care of by the multiple STAs of the non-AP MLD and/or the multiple APs of the AP MLDs.

There may be no interconnections between the multiple links in terms of power management mode or power state transitions. The multiple links may be independent from this perspective and an AP of an AP MLD may serve a STA of a non-AP MLD from power saving perspective as if the STA of the non-AP MLD was a legacy STA. Power save buffering and indication of pending buffered traffic may be on MLD level in an AP MLD. Indication of pending buffered traffic may be based on beacon frames and fields like partial virtual bitmap of traffic indication map element in beacon frames. All APs of an AP MLD may indicate same status of pending buffered traffic for non-AP MLDs in beacon frames they transmit

Each STA of a non-AP MLD may not be expected to monitor beacon frames, such as frames containing a delivery traffic indication map or a partial virtual bitmap of traffic indication map element. It may be enough for only one STA of a non-AP MLD to monitor beacon frames and to determine whether there are unicast and/or groupcast frames buffered by an AP of the AP MLD directed to a STA of the non-AP MLD.

It will be understood that in this disclosure groupcast frames may also be referred to as group addressed frames. Groupcast frame may comprise groupcast data frames.

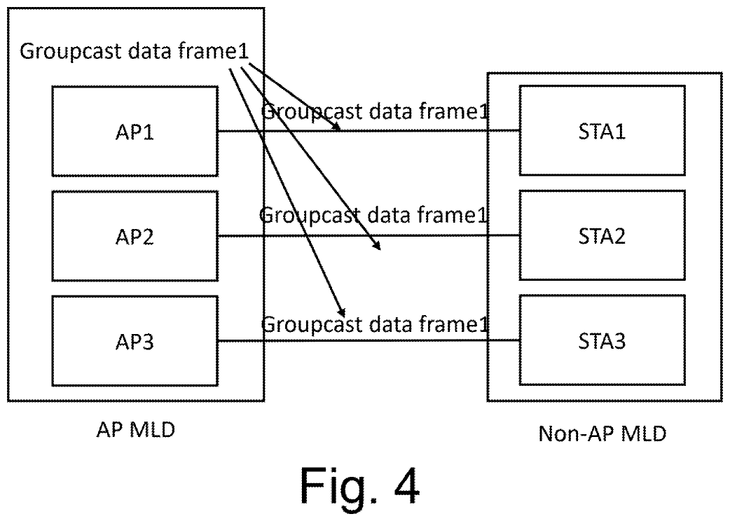

Per the decisions made in the task group TGbe, groupcast data type frames may be duplicated by all APs of an AP MLD so that all STAs of non-AP MLD can receive the groupcast frames on respective links. This approach is illustrated in FIG. 4.

FIG. 4 illustrates an AP MLD and a non-AP MLD. The AP MLD comprises an AP1, an AP2 and an AP3. The non-AP MLD comprises a STA1, a STA2 and a STA3. A first link is established between AP1 and STA1. A second link is established between AP2 and STA2. A third link is established between AP3 and STA3. A groupcast data frame 1 may be duplicated and may be transmitted by AP1 to STA1 over the first link, by AP2 to STA2 over the second link and by AP3 to STA3 over the third link.

According to the current IEEE 802.11 specification, if a STA associated to an AP via a link is in power save (PS) mode, the AP may be responsible for buffering all groupcast frames and deliver them to the STA of the non-AP MLD immediately following the next beacon frame containing a delivery traffic indication map (DTIM) after which buffered groupcast frames are transmitted before transmission of any unicast frames.

Even if the 802.11be multi-link may change the association to happen on the MLD level between a non-AP MLD and an AP MLD, buffering rules and delivery of buffered traffic may not change. In other words, if any STA of a non-AP MLD connected to an AP of an AP MLD via a link is in power save (PS) mode, the AP of the AP MLD may be responsible for buffering all groupcast frames and deliver them to the STA of the non-AP MLD immediately following the next beacon frame containing a delivery traffic indication map (DTIM) after which buffered groupcast frames are transmitted before transmission of any unicast frames.

The 802.11 specification defines two mechanisms to signal operating mode setting changes: the operating mode notification mechanism and the operating mode indication mechanism. The operating mode notification mechanism was introduced to the specification as part of the 802.11ac amendment. The operating mode indication mechanism was introduced as part of the 802.11ax amendment. Both the operating mode notification mechanism and the operating mode indication mechanism are designed for the same purpose: signalling operating mode changes.

The operating mode notification mechanism builds upon use of very high throughput (VHT) action frames (i.e. 802.11ac). A STA of a non-AP MLD may use the operating mode notification mechanism to notify an AP of an AP MLD that the STA of a non-AP MLD changes an operating channel width, a maximum number of spatial streams it can receive and/or a low density parity check (LDPC) receive preference.

The operating mode indication mechanism builds upon use of an operation mode (OM) control subfield. The OM control subfield may be carried in most of the frames a STA of a non-AP MLD device may transmit after association with an AP of an AP MLD.

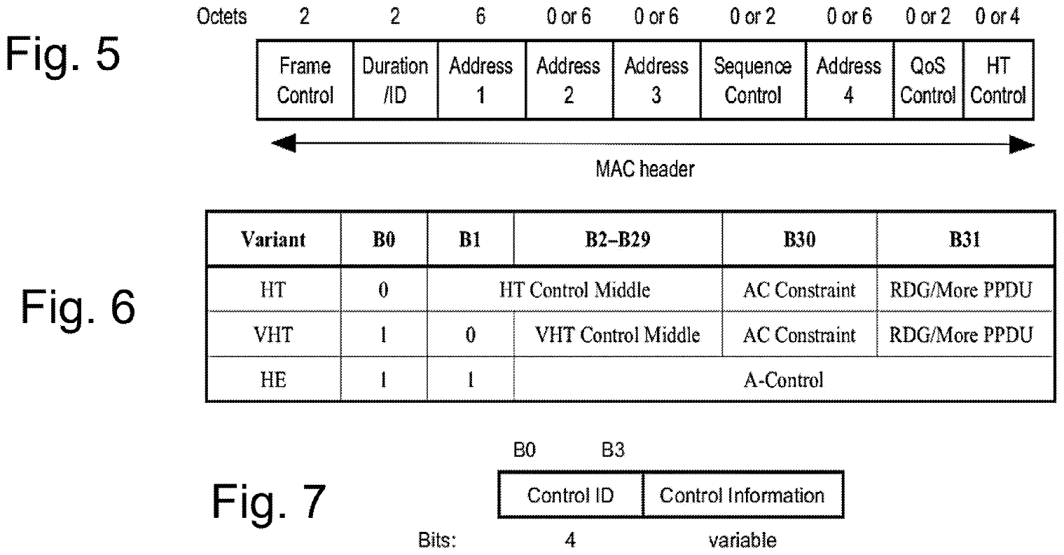

A STA of a non-AP MLD may use the operating mode indication mechanism to notify an AP of an AP MLD that the STA of a non-AP MLD changes receive operating parameters and/or transmit operating parameters. In terms of the receive operating parameters, a STA of a non-AP MLD may use the operating mode indication mechanism to notify an AP of an AP MLD that the STA of a non-AP MLD changes a maximum operating channel width and/or a maximum number of spatial streams. The OM control subfield is one of the subfields carried in the high efficiency (HE) variant of the high throughput (HT) control field as specified in the 802.11ax amendment. The HT control field is one of the fields in the MAC header as illustrated in FIG. 5.

FIG. 5 illustrates a MAC header comprising a frame control field, a duration/identifier (ID) field, an address 1 field, an address 2 field, an address 3 field, a sequence control field, an address 4 field, a quality of service (QOS) field and a HT high throughput (HT) control field.

The HE variant may be determined when the first two bits of the HT control field are set to ‘1’ as shown in FIG. 6. The 30-bit A-Control subfield may contain one or more control subfields and padding if needed.

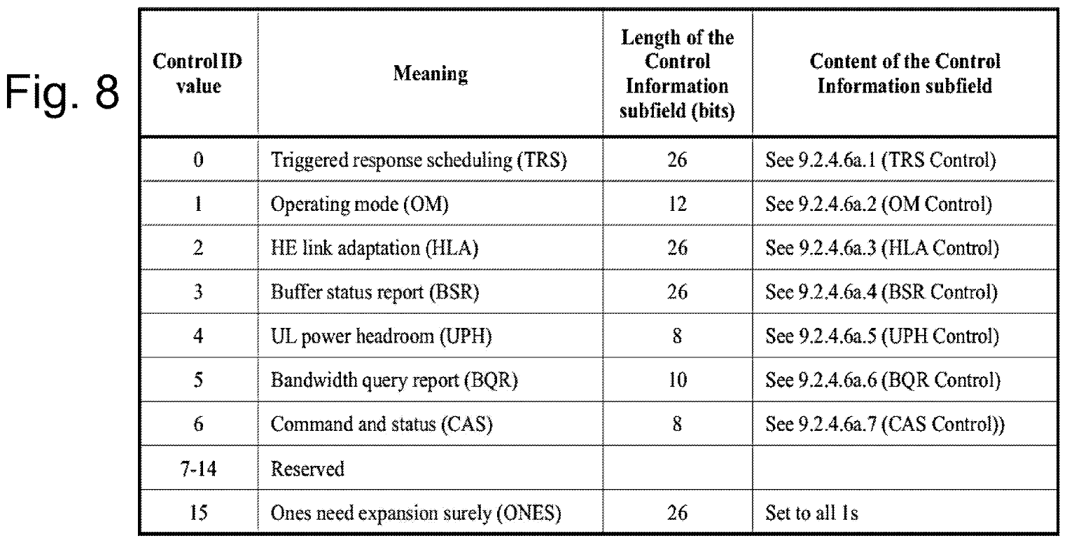

Each Control subfield may have the structure illustrated in FIG. 7 with the first four bits comprising a control ID subfield and the subsequent bits comprising a control information subfield.

The control ID may identify the type of information carried in the control information subfield for which possible values are listed in FIG. 8. It will be understood that FIG. 8 shows possible values but other possible values may be contemplated.

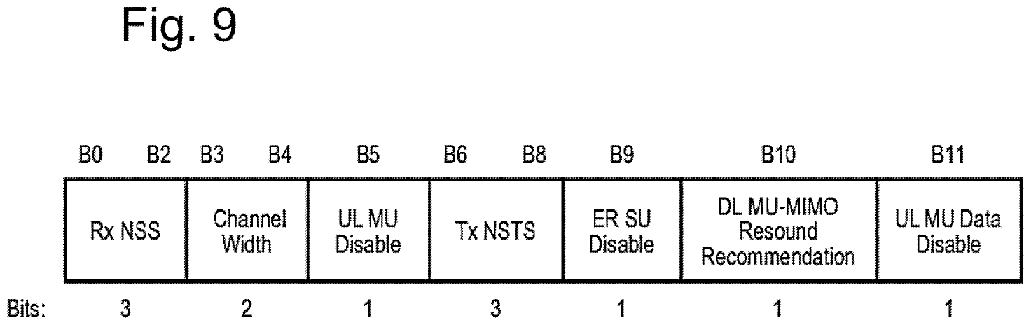

The control ID value may be set to ‘1’ to identify that the type of information carried in the control information subfield is OM. The structure of the control information subfield is illustrated in FIG. 9.

The control information subfield may comprise a receive (Rx) number of spatial streams (NSS) subfield, a channel width subfield, an uplink (UL) multi-user (MU) disable subfield, a transmit (Tx) number of space-time streams (NSTS) subfield, an extended range (ER) single user (SU) disable subfield, a downlink (DL) multi-user multiple input multiple output (MU-MIMO) resound recommendation subfield and a UL MU data disable subfield.

Delays may be experienced by a legacy STA due to a STA of a non-AP MLD in power save mode.

In order to reduce power consumption, a non-AP MLD may operate only one STA in power active mode and operate other STAs in power save mode.

The STA of the non-AP MLD in power active mode may receive groupcast frames without any delay (as long as the AP of the AP MLD connected with the STA of the non-AP MLD in power active mode is not further connected with another STA in power save mode, such a legacy STA or a STA of another non-AP MLD in power save mode).

The other STAs of the AP MLD in power save mode may cause other APs of the AP MLD connected with the other STAs of the non-AP MLD in power save mode to buffer duplicated groupcast frames and to deliver the duplicated groupcast frames only after a beacon frame containing a delivery traffic indication map (DTIM) is transmitted.

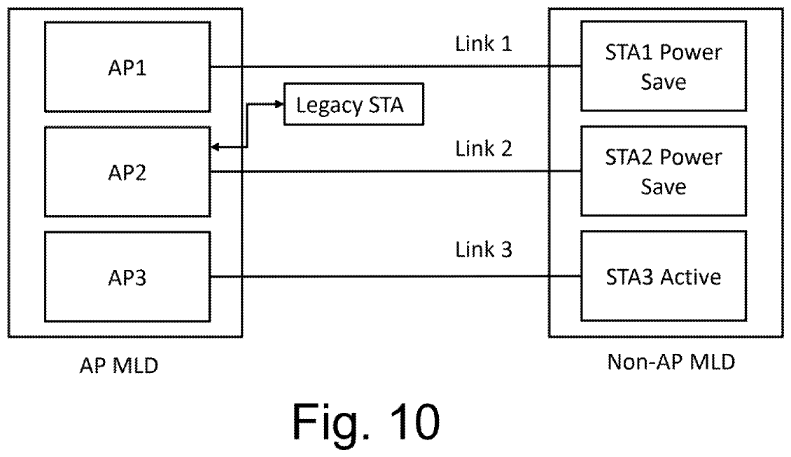

Legacy STAs in power active mode associated with the other APs of the AP MLD may receive duplicated groupcast frames with a delay. Such a delay is unnecessary if the buffering at the other APs of the AP MLD is due to the non-AP MLD. Indeed, the STA of the non-AP MLD in power active mode may already receive groupcast frames without delay. This will be better understood in relation to FIG. 10.

FIG. 10 illustrates an AP MLD and a non-AP MLD. The AP MLD comprises an AP1, an AP2 and an AP3. The non-AP MLD comprises a STA1, a STA2 and a STA3. A first link is established between AP1 and STA1. A second link is established between AP2 and STA2. A third link is established between AP3 and STA3.

The third link may be configured to receive groupcast frames. STA3 may be in power active mode. The first link may be configured not to receive groupcast frames from AP1. STA1 may be in power save mode. The second link may be configured not to receive groupcast frames from AP2. STA2 may be in power save mode.

More generally, it will be understood that a non-AP MLD may use one or more STAs (and corresponding links) to receive groupcast frames. The non-AP MLD may configure the STAs in terms of power management mode independently from whether the links are configured to receive groupcast frames or not. Typically, the STAs associated with links configured to receive groupcast frames are operated in power active mode (but they could alternatively operate in power save mode).

The groupcast frames may provide an internet protocol television (IPTV) service or another service.

FIG. 10 also illustrates a legacy STA. A legacy link is established between AP2 and the legacy STA. The legacy link may be configured to receive groupcast data frames from AP2. The legacy STA may be in power active mode.

It may be noticed that the legacy link is configured to receive groupcast data frames from AP2 while the second link is configured not to receive groupcast data frames from AP2. The legacy STA may be in power active mode whereas STA2 may be in power save mode. Because STA2 may be in power save mode, AP2 may have to buffer the groupcast frames and transmit the buffered groupcast frames after transmitting a DTIM beacon frame. The legacy STA will thus receive the groupcast frames with a delay.

Additionally, or alternatively, delays may be experienced by STAs of a non-AP MLDs due to STAs of other non-AP MLDs in power save mode.

Delays may be experienced by STAs of the non-AP MLD due to an incompatibility between STAs of the non-AP MLD in power active mode and STAs of other non-AP MLDs in power save mode. Such incompatibility may be due to the fact that the non-AP MLD and the other non-AP MLD may independently operates their STAs in power save mode and power active mode.

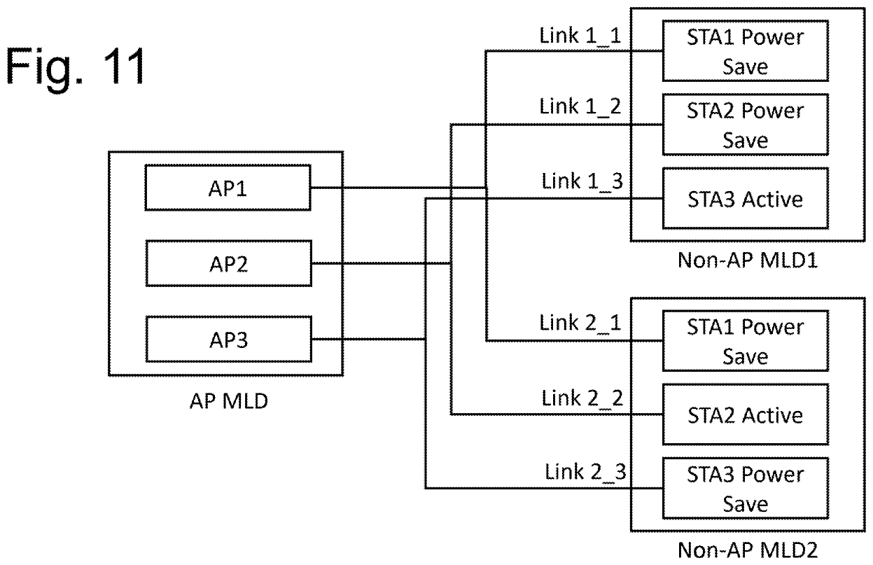

An AP of an AP MLD may serve a STA of the non-AP MLD and a STA of the other non-AP MLD. The STA of the non-AP MLD may be in power active mode whereas the STA of the other non-AP MLD may be in power save mode. The AP of the AP MLD may then have to buffer groupcast frames and transmit the buffered groupcast frames after transmitting a DTIM beacon frames. The STA of the non-AP MLD will thus receive the groupcast frames with a delay. This will be better understood in relation to FIG. 11.

FIG. 11 illustrates an AP MLD, a non-AP MLD1 and a non-AP MLD2. The AP MLD comprises an AP1, an AP2 and an AP3.

The non-AP MLD1 comprises a STA1, a STA2 and a STA3. A first link is established between AP1 and STA1. A second link is established between AP2 and STA2. A third link is established between AP3 and STA3. The first link may be configured not to receive groupcast frames from AP1. STA1 may be in power save mode. The second link may be configured not to receive groupcast frames from AP2. STA2 may be in power save mode. The third link may be configured to receive duplicated groupcast frames from AP3. STA3 may be in power active mode.

The non-AP MLD2 comprises a STA1, a STA2 and a STA3. A first link is established between AP1 and STA1. A second link is established between AP2 and STA2. A third link is established between AP3 and STA3. The first link may be configured not to receive groupcast frames from AP1. STA1 may be in power save mode. The second link may be configured to receive groupcast frames from AP2. STA2 may be in power active mode. The third link may be configured not to receive duplicated groupcast frames from AP3. STA3 may be in power save mode.

In another example, the first link and the third link may be neither configured not to receive groupcast frames nor configured to receive groupcast frames (i.e. the configuration of the first link and the third link is unspecified by the non-AP MLD2).

In that example case, STA1 and STA3 may receive groupcast frames if STA1 and STA3 are in power active mode if and when groupcast frames are transmitted via the first link and the third link. However, the non-AP MLD2 does not need to receive groupcast frames via STA1 or STA3, since it is sufficient if the non-AP MLD receives groupcast frames via STA2 that is associated with the second link configured to receive groupcast frames.

The groupcast frames may provide an internet protocol television (IPTV) service or another service.

It may be noticed that AP2 serves STA2 of non-AP MLD2 in power active mode. However, AP2 also serves STA2 of non-AP MLD1 in power save mode. Because STA2 of non-AP MLD1 is in power save mode, AP2 may have to buffer the groupcast frames and transmit the buffered groupcast frames after transmitting a DTIM beacon frame. STA2 of non-AP MLD2 will thus receive the groupcast frames with a delay.

It may be noticed that AP3 serves STA3 of non-AP MLD1 in power active mode. However, AP3 also serves STA3 of non-AP MLD2 in power save mode. Because STA3 of non-AP MLD2 is in power save mode, AP3 may have to buffer the groupcast frames and transmit the buffered groupcast frames after transmitting a DTIM beacon frame. STA3 of non-AP MLD1 will thus receive the groupcast frames with a delay.

The above problems are new to 802.11 and result from the current definitions of 802.11be. There are no solutions yet available.

One or more aspects of the disclosure provide a mechanism to allow a non-AP MLD to indicate to an AP MLD a link configured to receive groupcast frames. A link configured to receive groupcast frames may be a link established between a STA of the non-AP MLD and an AP of the AP MLD. The STA of the non-AP MLD may be in power active mode.

One or more other links may be configured to receive the groupcast frames. These one or more other links may be a subset of links established between STAs of the non-AP MLD and other APs of the AP MLD. The STA(s) of the non-AP MLD may be in power save mode.

The AP MLD may use this indication to determine whether a STA of the non-AP MLD is in power save mode and whether the AP of the AP MLD serving the STA of the non-AP MLD in power save mode needs to buffer groupcast frames and transmit the buffered groupcast frames after transmitting a DTIM beacon frame. The AP of the AP MLD serving the STA of the non-AP MLD in power save mode may abstain from buffering groupcast frames and abstain from transmitting the buffered groupcast frames after transmitting a DTIM beacon frame.

One or more aspects of the disclosure provide a mechanism to allow an AP MLD to indicate to a non-AP MLD a suggested link to be configured to receive groupcast frames.

The AP MLD may determine that an AP of the AP MLD serving a STA of a non-AP MLD in power save mode may abstain from buffering groupcast frames and abstain from transmitting the buffered groupcast frames after transmitting a DTIM beacon frame if the STA of the non-AP MLD is changed from being in power save mode to being in power active mode and if another STA of the non-AP MLD is changed from being in power active mode to being in power save mode to address an incompatibility between the STAs of the non-AP MLD and STAs of another non-AP MLD.

By addressing the incompatibility between the STAs of the non-AP MLD and STAs of another non-AP MLD, groupcast frame buffering could be avoided and less STAs may experience delays in groupcast frame delivery.

### Means for a Non-AP MLD to Indicate a Link Configured to Receive Groupcast Frames to an AP MLD and Actions Taken by the AP MLD Receiving Such an Indication

A link configured to receive groupcast frames by a non-AP MLD may be treated as an operating mode parameter. A mechanism may be provided in the 802.11be amendment to allow the non-AP MLD to indicate the link configured to receive groupcast frames to the AP MLD.

The operating mode notification mechanism and the operating mode indication mechanism described above may not be suitable for this purpose. The operating mode notification mechanism uses an element format which has a fixed size and is thus difficult to extend. The operating mode indication mechanism has a similar limitation as it has fixed 12 bits length which makes it hard to extend to include new information.

The HE variant of the HT control field illustrated in FIG. 6 and the control subfield illustrated in FIG. 7 however may provide a good basis for a mechanism to allow the non-AP MLD to indicate a link configured to receive groupcast frames to the AP MLD.

In an implementation a new multi-link mode control subfield may be defined to allow the non-AP MLD to indicate a link configured to receive groupcast frames to the AP MLD. More specifically, a new multi-link mode control subfield of an A-Control subfield of a HE variant of a HT control field may be defined to allow the non-AP MLD to indicate a link configured to receive groupcast frames to the AP MLD.

The new multi-link mode control subfield of an A-Control subfield of a HE variant of a HT control field may comprise a control ID and control information. The value of the control ID may be set to a value comprised between ‘7’ and ‘14’ (these values are currently reserved). For example, the value of the control ID may be set to ‘8’.

The control information may indicate a link configured to receive groupcast frames, that is the link established between a STA of the non-AP MLD and an AP of the AP MLD. The STA of the non-AP MLD may be in power active mode.

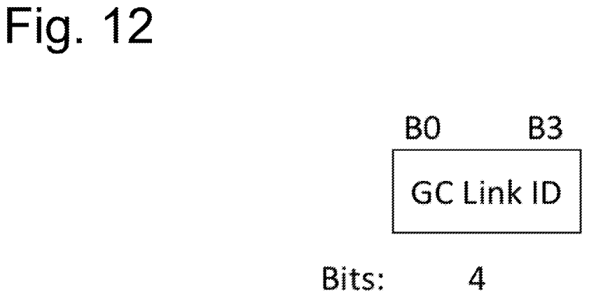

An exemplary format of the control information to allow the non-AP MLD to indicate, a groupcast (GC) link ID, that is the link configured to receive groupcast frames to the AP MLD, is illustrated in FIG. 12. The control information may comprise four bits.

It will be understood that multiple links may be configured to receive the groupcast frames. These multiple links may be links established between STAs of the non-AP MLD and other APs of the AP MLD- or subset of those links. The STAs of the non-AP MLD may be in power active mode. The GC ID may indicate the multiple links configured to receive groupcast frames. In an example, there may be three links established and two of those links may be configured to receive the groupcast frames.

If a frame has the new multi-link mode control subfield and the frame is transmitted by the non-AP MLD to the AP MLD, the GC Link ID may indicate the link configured to receive groupcast frames by the non-AP MLD to the AP MLD. The link may be established between a STA of the non-AP MLD and an AP of the AP MLD. The STA of the non-AP MLD may be in power active mode.

The AP MLD may configure other APs to abstain from buffering groupcast frames and abstain from transmitting the buffered groupcast frames after transmitting a DTIM beacon frame.

In the event that the other APs of the AP MLD serve a legacy STA and/or a STA of another non-AP MLD, the AP MLD may buffer groupcast frames and transmit the buffered groupcast frames after transmitting a DTIM beacon frame only if a link between the legacy STA and/or the STA of another non-AP MLD is configured to receive the groupcast frames and if a the legacy STA and/or the STA of another non-AP MLD is in power saved mode.

In other words, the AP MLD may configure the other APs to abstain from buffering groupcast frames and abstain from transmitting the buffered groupcast frames after transmitting a DTIM beacon frame if a link between the legacy STA and/or the STA of another non-AP MLD is configured to abstain from receiving the groupcast frames.

The AP MLD may configure the other APs to abstain from buffering groupcast frames and abstain from transmitting the buffered groupcast frames after transmitting a DTIM beacon frame if a link between the legacy STA and/or the STA of another non-AP MLD is configured to receive the groupcast frames and if the legacy STA and/or the STA of another non-AP MLD is in power active mode.

The AP MLD may configure the other AP(s) to abstain from buffering groupcast frames and abstain from transmitting the buffered groupcast frames after transmitting a DTIM beacon frame if the other AP have:
no links with legacy STAs that are in power save mode, and
no links with STAs of non-AP MLDs wherein the STAs are in power save mode and indicated as configured to receive groupcast frames.

### Means for an AP MLD to Indicate a Suggested Link Configured to Receive Groupcast Frames to a Non-AP MLD and Actions Taken by the Non-AP MLD Receiving Such an Indication

In an implementation, an AP MLD may indicate a suggested link configured to receive groupcast frames to the non-AP MLD within a multi-link element and especially within a per-STA profile sub-element within multi-link element. A multi-link element may be carried in frames like beacon frames, probe response frames and/or association response frames. With this approach, an AP MLD may assign, as an example, some of its APs and corresponding links as preferred groupcast APs/links.

It will be understood that multiple suggested links may be configured to receive the groupcast frames. The multi-link element may indicate the multiple suggested links configured to receive groupcast frames to the non-AP MLD.

In another implementation the new multi-link mode control subfield of an A-Control subfield of a HE variant of a HT control field described above may additionally or alternatively be defined to allow the AP MLD to indicate a suggested link configured to receive groupcast frames to the non-AP MLD.

As described above, the new multi-link mode control subfield of an A-Control subfield of a HE variant of a HT control field may comprise a control ID and control information. The value of the control ID may be set to a value comprised between ‘7’ and ‘14’ (these values are currently reserved). For example, the value of the control ID may be set to ‘8’.

The control information may indicate a suggested link configured to receive groupcast frames, that is the suggested link established between a STA of the non-AP MLD and an AP of the AP MLD. The STA of the non-AP MLD may be in power active mode. The non-AP MLD may follow the AP MLD suggestion and may change a STA of the non-AP MLD from being in power save mode to being in power active mode and may change another STA of the non-AP MLD from being in power active mode to being in power save mode.

An exemplary format of the control information to allow the AP MLD to indicate, a groupcast (GC) link ID, that is the suggested link configured to receive groupcast frames to the AP MLD, is illustrated in FIG. 12. The control information may comprise four bits

It will be understood that multiple suggested links may be configured to receive the groupcast frames. Multiple GC link ID subfields may be used indicate the multiple suggested links configured to receive groupcast frames to the non-AP MLD.

If a frame has the new multi-link mode control subfield and the frame is transmitted by the AP MLD to the non-AP MLD, the GC Link ID may indicate the suggested link configured to receive groupcast frames by the non-AP MLD.

In the event that multiple GC Link ID subfields are transmitted, they may indicate multiple suggested links configured to receive groupcast frames by the non-AP MLD, and the multiple suggested links may be given in a priority order.

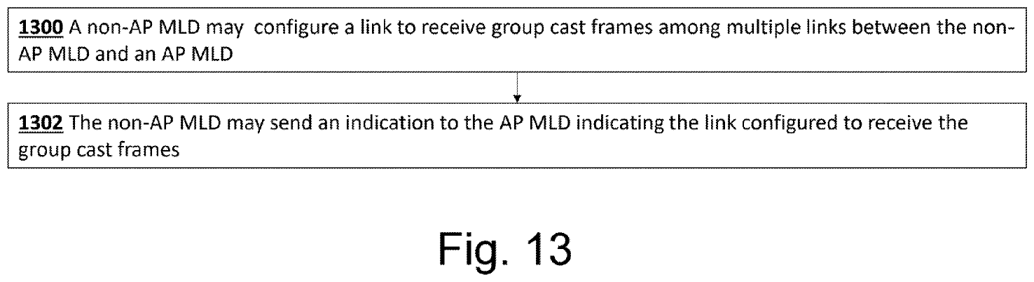

FIG. 13 shows a block diagram of a method for sending an indication to AP MLD indicating a link configured to receive groupcast frames among multiple links between a non-AP MLD and the AP MLD.

In step 1300, a non-AP MLD may configure a link to receive groupcast frames among multiple links between the non-AP MLD and an AP MLD.

In step 1302, the non-AP MLD may send an indication to the AP MLD indicating the link configured to receive the groupcast frames.

The link configured to receive the groupcast frames is between a STA of the non-AP MLD and an AP of the AP MLD. The station may be in power active mode.

The non-AP MLD may configure one or more other links to receive the groupcast frames or to abstain from receiving the groupcast frames among the multiple links between the non-AP MLD and the AP MLD.

The one or more other links configured to receive the groupcast frames or to abstain from receiving the groupcast frames are between other STAs of the non-AP MLD and other APs of the AP MLD. The one or more other STAs of the non-AP MLD may be in power save mode.

The indication may be sent on the link configured to receive the groupcast frames.

The indication may be comprised in a control field of a MAC header.

The indication may be comprised in a HT control field of a MAC header.

The indication may be comprised in a NE variant of a HT control field of a MAC header.

The indication may be comprised in a control subfield of an A-Control subfield of a HE variant of a HT control field of a MAC header.

The control subfield may comprise a control ID and control information.

The control ID may indicate multiple links between the non-AP MLD and the AP MLD.

The control ID may have a value comprised between ‘7’ and ‘14’.

The control information may indicate an ID of the link configured to receive the groupcast frames.

The non-AP MLD may receive an indication from the AP MLD indicating a suggested link to receive groupcast frames among the multiple links between the non-AP MLD and the AP MLD. The non-AP MLD may configure the suggested link to receive the groupcast frames.

The indication may be sent on the link configured to receive the groupcast frames.

The indication may be comprised in a control field of a MAC header.

The indication may be comprised in a HT control field of a MAC header.

The indication may be comprised in a HE variant of a HT control field of a MAC header.

The indication may be comprised in a control subfield of an A-Control subfield of a HE variant of a HT control field of a MAC header.

The control subfield may comprise a control ID and control information.

The control identifier may indicate a mode control with multiple links between the non-AP MLD and an AP MLD.

The control ID may have a value comprised between ‘7’ and ‘14’.

The control information may indicate an ID of the suggested link configured to receive a groupcast frame among the multiple links between the non-AP MLD and an AP MLD.

The groupcast frames may provide an IPTV service.

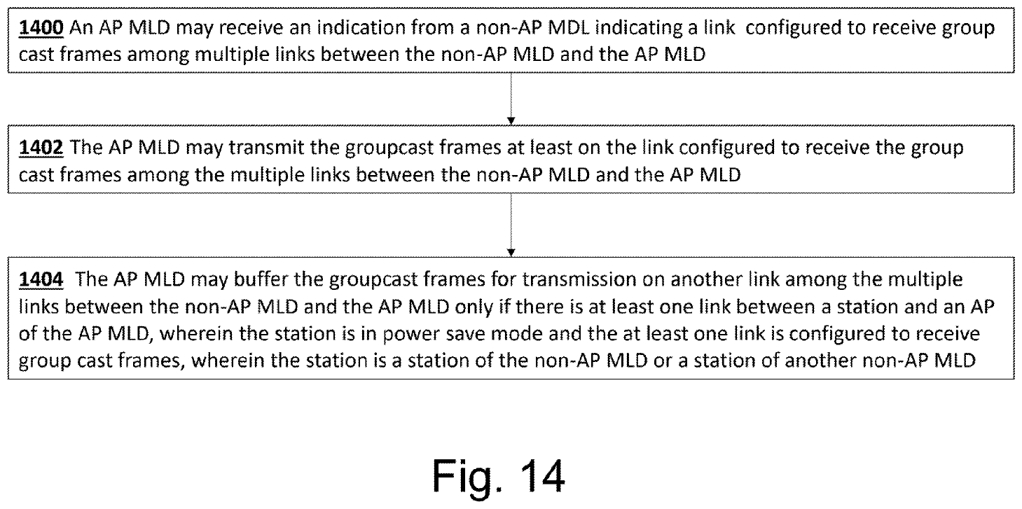

FIG. 14 shows a block diagram of a method for receiving an indication from an AP MLD indicating a link configured to receive groupcast frames among multiple links between a non-AP MLD and the AP MLD.

In step 1400, an AP MLD may receive an indication from a non-AP MLD indicating a link configured to receive groupcast frames among multiple links between the non-AP MLD and the AP MLD.

In step 1402, the AP MLD may transmit the groupcast frames at least on the link configured to receive the groupcast frames among the multiple links between the non-AP MLD and the AP MLD.

In step 1404, the AP MLD may buffer the groupcast frames for transmission on another link among the multiple links between the non-AP MLD and the AP MLD only if there is at least one link between a STA and an AP of the AP MLD. The STA may be in power save mode. The at least one link may be configured to receive groupcast frames. The STA may be a STA of the non-AP MLD or a STA of another non-AP MLD.

The link configured to receive the groupcast frames may be between a STA of the non-AP MLD and an AP of the AP MLD. The STA of the non-AP MLD may be in power active mode.

The AP MLD may configure the AP of the AP MLD to send the groupcast frames.

The AP MLD may determine that one or more other links are configured to receive the groupcast frames or to abstain from receiving the groupcast frames among the multiple links between the non-AP MLD and the AP MLD.

The one or more other links configured to receive the groupcast frames or to abstain from receiving the groupcast frames may be between other STAs of the non-AP MLD and other APs of the AP MLD. The other STAs of the non-AP MLD may be in power save mode.

The AP MLD may send an indication to the non-AP MLD indicating a suggested link to receive a groupcast frame among the multiple links.

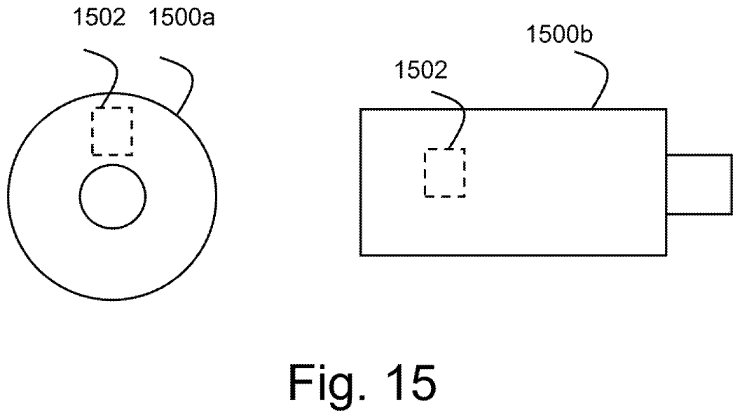

FIG. 15 shows a schematic representation of non-volatile memory media 1500a (e.g. computer disc (CD) or digital versatile disc (DVD)) and 1500b (e.g. universal serial bus (USB) memory stick) storing instructions and/or parameters 1502 which when executed by a processor allow the processor to perform one or more of the steps of the methods of FIGS. 13 and 14.

It is noted that while the above describes example embodiments, there are several variations and modifications which may be made to the disclosed solution without departing from the scope of the present invention.

It will be understood that although the above concepts have been discussed in the context of a 5GS, 802.11 and Wi-Fi. One or more of these concepts may be applied in other contexts.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 12 and 13, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one non-transitory memory storing instructions that, when executed with the at least one processor, cause the apparatus at least to:
configure a link to receive groupcast frames among multiple links between the apparatus and an access node apparatus; and
send an indication to the access node apparatus indicating the link configured to receive the groupcast frames.

2. The apparatus of claim 1, wherein the link configured to receive the groupcast frames is between a station of the apparatus and an access node of the access node apparatus, wherein the station is in power active mode.

3. The apparatus of claim 1, wherein the instructions are configured, with the at least one processor, to cause the apparatus at least to:
configure one or more other links to receive the groupcast frames or to abstain from receiving the groupcast frames among the multiple links between the apparatus and the access node apparatus.

4. The apparatus of claim 3, wherein the one or more other links configured to receive the groupcast frames or to abstain from receiving the groupcast frames are between other stations of the apparatus and other access nodes of the access node apparatus, wherein the one or more other stations of the apparatus are in power save mode.

5. The apparatus of claim 1, wherein the indication is sent on the link configured to receive the groupcast frames.

6. The apparatus of claim 1, wherein the indication is comprised in a control field of a medium access control header.

7. The apparatus of claim 6, wherein the indication is comprised in a high throughput control field of a medium access control header.

8. The apparatus of claim 7, wherein the indication is comprised in a high efficiency variant of a high throughput control field of a medium access control header.

9-13. (canceled)

14. The apparatus of claim 1, wherein the instructions are configured, with the at least one processor, to cause the apparatus at least to:
receive an indication from the access node apparatus indicating a suggested link to receive groupcast frames among the multiple links between the apparatus and the access node apparatus; and
configure the suggested link to receive the groupcast frames.

15. The apparatus of claim 1, wherein the groupcast frames provide an internet protocol television service.

16. An apparatus comprising:
at least one processor; and
at least one non-transitory memory storing instructions that, when executed with the at least one processor, cause the apparatus at least to:
receive an indication from a non-access node apparatus indicating a link configured to receive groupcast frames among multiple links between the non-access node apparatus and the apparatus;
transmit the groupcast frames at least on the link configured to receive the groupcast frames among the multiple links between the non-access node apparatus and the apparatus; and
buffer the groupcast frames for transmission on another link among the multiple links between the non-access node apparatus and the apparatus when there is at least one link between a station and an access node of the apparatus, wherein the station is in power save mode and the at least one link is configured to receive groupcast frames, wherein the station is a station of the non-access node apparatus or a station of another non-access node apparatus.

17. The apparatus of claim 16, wherein the link configured to receive the groupcast frames is between a station of the non-access node apparatus and an access node of the apparatus, wherein the station of the non-access node apparatus is in power active mode.

18. The apparatus of claim 17, wherein the instructions are configured, with the at least one processor, to cause the apparatus at least to:
configure the access node of the access node apparatus to send the groupcast frames.

19. The apparatus of claim 16, wherein the instructions are configured, with the at least one processor, to cause the apparatus at least to:
determine that one or more other links are configured to receive the groupcast frames or to abstain from receiving the groupcast frames among the multiple links between the non-access node apparatus and the apparatus.

20. The apparatus of claim 19, wherein the one or more other links configured to receive the groupcast frames or to abstain from receiving the groupcast frames are between other stations of the non-access node apparatus and other access nodes of the apparatus, wherein the other stations of the non-access node apparatus are in power save mode.

21. The apparatus of claim 16, wherein the instructions are configured, with the at least one processor, to cause the apparatus at least to:
send an indication to the non-access node apparatus indicating a suggested link to receive a groupcast frame among the multiple links.

22. A method comprising:
configuring a link to receive groupcast frames among multiple links between an apparatus and an access node apparatus; and
sending an indication to the access node apparatus indicating the link configured to receive the groupcast frames.

23. A method comprising:
receiving an indication from a non-access node apparatus indicating a link configured to receive groupcast frames among multiple links between the non-access node apparatus and an apparatus;
transmitting the groupcast frames at least on the link configured to receive the groupcast frames among the multiple links between the non-access node apparatus and the apparatus; and
buffering the groupcast frames for transmission on another link among the multiple links between the non-access node apparatus and the apparatus when there is at least one link between a station and an access node of the apparatus, wherein the station is in power save mode and the at least one link is configured to receive groupcast frames, wherein the station is a station of the non-access node apparatus or a station of another non-access node apparatus.

24. A non-transitory computer readable medium comprising program instructions that, when executed with the apparatus, cause the apparatus to perform the method as claimed in claim 22.

25. A non-transitory computer readable medium comprising program instructions that, when executed with the apparatus, cause the apparatus to perform the method as claimed in claim 23.
